(19) United States
(12) Patent Application Publication
(10) Pub. No.: US 2026/0311240 A1
(43) Pub. Date: Oct. 8, 2026

(54) METHODS AND SYSTEMS FOR FACILITATING ENVIRONMENTALLY CONSCIOUS OWNERSHIP OF ELECTRONIC PRODUCTS

(71) Applicant: KM GROUP HOLDINGS LLC, Austin, TX (US)

(72) Inventor: Vishnu Muthuraman, Austin, TX (US)

(21) Appl. No.: 19/220,504

(22) Filed: May 28, 2025

(30) Foreign Application Priority Data
Apr. 4, 2025 (IN) 202541033478

(51) Int. Cl. G06Q 30/0601

(52) U.S. Cl. CPC G06Q 30/06311; G06Q 30/0623

(57) ABSTRACT

A method for facilitating environmentally conscious ownership of electronic products, performed by a server system, includes providing access to at least one instance of a software application, on at least one first electronic device and one or more second electronic devices associated, to configure an online social network of users. The method further includes receiving product information related to a plurality of electronic products. Furthermore, the method includes determining an environmental rating for each one of the electronic products. Furthermore, the method includes receiving a product category for purchase. The method also includes providing one or more purchase recommendations to the at least one first electronic device for the product category based at least on the environmental ratings.

### TECHNICAL FIELD

The present disclosure generally relates to managing the environmental impacts of electronic products and more specifically, to facilitating environmentally conscious ownership of electronic products by users to help the users make better purchasing decisions, extend the operational lifespan of the electronic products, and reduce electronic waste (e-waste).

### BACKGROUND

The rapid proliferation of consumer electronic devices (such as Televisions, computers, smartphones, sound systems, etc.) and smart electronically controlled home appliances (such as refrigerators, washing machines, fans, water heaters, etc.) has led to a substantial increase in the generation of e-waste, which contains hazardous materials such as lead, cadmium, mercury, chromium-vi, that pose significant environmental and public health risks if improperly managed. Traditional approaches to e-waste management have primarily focused on recycling and responsible disposal at the end of the lifecycle of an electronic device. However, these measures fail to address the underlying causes of e-waste generation, including accelerated device obsolescence, inefficient usage patterns, and insufficient user awareness of sustainable practices.

In e-commerce, recommendation systems typically emphasize promoting sales by suggesting products based on user preferences, browsing history, or purchasing behavior. These systems often lack consideration for the long-term environmental impacts of the recommended products or the user's ability to maintain, repair, or utilize them efficiently. As a result, such platforms fall short of encouraging environmentally conscious purchasing decisions that align with user needs while promoting product longevity and sustainability.

Existing device management tools are similarly limited in their scope, focusing on basic inventory tracking or providing generic maintenance information. They often fail to leverage insights derived from user behavior, preferences, or usage patterns to encourage sustainable practices. Furthermore, a significant portion of users remain unaware of the environmental implications of their purchasing decisions or lack the knowledge and resources required to maintain or repair their devices effectively. While certain marketplace platforms offer basic product comparisons, they rarely incorporate advanced features such as behavioral analytics, predictive recommendations for enhancing product longevity, or metrics for assessing environmental sustainability.

Another critical limitation is the absence of streamlined communication channels amongst the users, including consumers and merchants (or sellers and resellers), leading to poor buying decisions. Consumers are often overwhelmed with marketing that emphasizes having the newest gadgets and features. This leads to a cycle of constantly upgrading devices, even if the old ones are still functional. Some manufacturers deliberately design products with a limited lifespan, encouraging consumers to replace them sooner. This can be through the use of low-quality components, making repairs difficult, or simply by making older models seem outdated. Many consumers, and even merchants (or sellers and resellers), are unaware of the hazardous materials in electronics and the environmental consequences of improper disposal. This lack of knowledge can lead to careless purchasing decisions and disposal practices. Consumers might not think about how easy or affordable it will be to repair a device if it breaks down. This can lead to discarding broken electronics instead of fixing them.

Furthermore, the lack of communication also leads to consumers not being completely aware of local repair shops, online resources for DIY repairs, or initiatives by manufacturers to support repairs. This lack of information leads to more devices being discarded instead of repaired. If recycling or repair options are inconvenient or time-consuming, consumers are less likely to participate. Moreover, there are often few incentives for consumers to recycle or repair their electronics. This can make it seem easier to just throw them away. Furthermore, the consumers may not have a clear understanding of how long their devices are expected to last or how to extend their lifespan through proper maintenance and repair. There are several undesirable downstream effects of lack of conscious ownership of electronic products such as the generation of large amounts of e-waste, the release of hazardous materials into the environment, contamination of soil, water, and air, loss of valuable materials because of lack of recycling, excessive consumption of energy and resources for manufacturing of new devices needed to replace the discarded ones.

Thus, there is a clear and pressing need for comprehensive systems and methods that integrate e-commerce product recommendations with sustainability considerations. Such systems and methods should not only align recommendations with user preferences but also prioritize environmentally sustainable products and practices. Additionally, they should provide consumers with personalized guidance for optimal product usage, predictive maintenance, and repair support while facilitating seamless communication with other consumers.

### SUMMARY

Various embodiments of the present disclosure provide methods and systems for facilitating environmentally conscious ownership of electronic products by users to help the users to make better purchasing decisions, extend the operational lifespan of the electronic products, and reduce e-waste.

According to an aspect of the present disclosure, there is provided a method for facilitating environmentally conscious ownership of electronic products by users. The method, performed by a server system, includes providing access to at least one instance of a software application, on at least one first electronic device associated with a first user and one or more second electronic devices associated with one or more second users. The at least one instance of the software application is capable of enabling the at least one first electronic device to connect with the one or more second electronic devices, to configure an online social network of users. The method further includes receiving product information related to a plurality of electronic products owned by the one or more second users. The product information is provided by the one or more second users to the at least one instance of the software application via the one or more respective second electronic devices. Furthermore, the method includes determining an environmental rating for each electronic product of the plurality of electronic products based, at least in part, on the respective product information. Furthermore, the method includes receiving a product category for purchase by the first user via the at least one first electronic device. The method also includes providing one or more purchase recommendations to the at least one first electronic device for the product category based at least on the environmental ratings of electronic products associated with the product category.

According to another aspect of the present disclosure, there is provided a server system for facilitating environmentally conscious ownership of electronic products by users. The server system includes a memory unit configured to store machine-readable instructions, and a processor configured to execute the machine-readable instructions stored in the memory unit and thereby enabling the server system, at least in part, to provide access to at least one instance of a software application, on at least one first electronic device associated with a first user and one or more second electronic devices associated with one or more second users. The at least one instance of the software application is capable of enabling the at least one first electronic device to connect with the one or more second electronic devices, to configure an online social network of users. The server system is further enabled to receive product information related to a plurality of electronic products owned by the one or more second users. The product information is provided by the one or more second users to the at least one instance of the software application via the one or more respective second electronic devices. Furthermore, the server system is enabled to determine an environmental rating for each electronic product of the plurality of electronic products based, at least in part, on the respective product information. Furthermore, the server system is enabled to receive a product category for purchase by the first user via the at least one first electronic device. The server system is also enabled to provide one or more purchase recommendations to the at least one first electronic device for the product category based at least on the environmental ratings of electronic products associated with the product category.

According to another aspect of the present disclosure, there is provided a non-transitory computer-readable storage medium including machine-readable instructions that, when executed by at least a processor of a server system, enable the server system to perform a method. The method includes providing access to at least one instance of a software application, on at least one first electronic device associated with a first user and one or more second electronic devices associated with one or more second users. The at least one instance of the software application is capable of enabling the at least one first electronic device to connect with the one or more second electronic devices, to configure an online social network of users. The method further includes receiving product information related to a plurality of electronic products owned by the one or more second users. The product information is provided by the one or more second users to the at least one instance of the software application via the one or more respective second electronic devices. Furthermore, the method includes determining an environmental rating for each electronic product of the plurality of electronic products based, at least in part, on the respective product information. Furthermore, the method includes receiving a product category for purchase by the first user via the at least one first electronic device. The method also includes providing one or more purchase recommendations to the at least one first electronic device for the product category based at least on the environmental ratings of electronic products associated with the product category.

### BRIEF DESCRIPTION OF THE FIGURES

For a more complete understanding of example embodiments of the present technology, reference is now made to the following descriptions taken in connection with the accompanying drawings in which:

FIG. 1 is an example representation of an environment related to at least some embodiments of the present disclosure;

FIG. 2 is a simplified block diagram representation of a server system, in accordance with an embodiment of the present disclosure;

FIG. 3 illustrates a block diagram illustrating a flow of information for facilitating environmentally conscious ownership of electronic products by users, in accordance with an embodiment of the present disclosure;

FIG. 4A illustrates a user interface for a second user, on a second electronic device, in accordance with an embodiment of the present disclosure;

FIG. 4B illustrates another user interface for the second user, on the second electronic device, in accordance with an embodiment of the present disclosure;

FIG. 5A illustrates a user interface for a first user, on at least one first electronic device, in accordance with an embodiment of the present disclosure;

FIG. 5B illustrates another user interface for the first user, on the at least one first electronic device, in accordance with an embodiment of the present disclosure;

FIG. 5C illustrates another user interface for the first user, on the at least one first electronic device, in accordance with an embodiment of the present disclosure;

FIG. 6 illustrates a method for facilitating environmentally conscious ownership of electronic products by users, in accordance with an embodiment of the present disclosure; and

FIG. 7 is a simplified block diagram of an electronic device, in accordance with various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “electronic products” are envisaged to include electronic devices/consumer electronics such as Televisions (TVs), smartphones, computers, headphones, etc. and home appliances such as washing machines, refrigerators, fans, water heaters, air conditioners, etc.

The term “user(s)” is envisaged to include both consumers and merchants (or sellers or resellers) of the electronic products.

The terms “environmentally sustainable products” and “environmentally friendly products” may have been used interchangeably throughout the description. Unless the context suggests otherwise, these terms refer to products designed, manufactured, or used in a manner that minimizes their environmental impact across their lifecycle. These terms specifically encompass electronic devices or components that are designed to reduce waste generation. These products aim to mitigate the negative environmental consequences of e-waste by promoting reuse, recycling, and prolonged usage, thereby reducing the accumulation of hazardous materials in landfills, associated with the electronic product.

Unless the context suggests otherwise, the term “lifecycle” of an electronic product refers to a period beginning with the product's acquisition (e.g. purchase) by the end-user and continuing through its usage, maintenance, and eventual disposal or end-of-life.

### OVERVIEW

Various example embodiments of the present disclosure provide methods and systems for facilitating environmentally conscious ownership of electronic products. A server system facilitates access to a software application for various electronic devices. This can be achieved through app store publication, direct download from a web-based URL, or using package managers. In some cases, organizations may utilize enterprise deployment tools for centralized installation and management. Alternatively, the software application can be installed in a cloud infrastructure, enabling access through web browsers, dedicated client applications, or virtual desktop infrastructures. This access allows users to connect and configure an online social network.

The server system also receives product information from users, which may include details like name, model number, manufacturer, images, cost, and technical specifications such as dimensions, power requirements, and materials. This information can be supplemented by data retrieved from online sources like manufacturer websites and e-commerce platforms. Furthermore, the server system gathers usage information and repair history for each electronic product. Usage information encompasses data points like power cycles, operating modes, feature usage, error logs, and energy consumption. Repair histories include details such as repair dates, descriptions of problems, diagnoses, parts replaced, labor, costs, warranty information, and service providers.

The server system utilizes this collected information to determine an environmental rating for each product. This rating is based on factors like longevity of use, repairability, recycled material content, recyclability, and biodegradability. These factors are quantified and scored to create a comprehensive sustainability profile. The server system also allows for the exchange of text and multimedia messages between users through the communication module. This module leverages real-time communication protocols to ensure instant message delivery and may utilize message queues for temporary storage. Additionally, content delivery networks (CDNs) can be used to efficiently deliver multimedia content. The system can also enable audio and video calling using real-time protocols like WebRTC, SIP, or RTP.

There are several advantages to the approach for the methods and systems presented in the aforementioned paragraphs. The environmental ratings would provide the consumer with clear and concise information about the environmental impact of their purchasing decisions. This would allow the consumers to make more informed choices and support companies that prioritize sustainability. The choice of products with higher environmental ratings would create market pressure for eco-friendly practices. The “longevity of use” factor would reward products designed for durability and repairability, discouraging planned obsolescence and promoting a “repair, reuse, recycle” mindset. Including the “possibility of repairing” factor would push manufacturers to design products that are easier and more affordable to fix, reducing waste and extending product lifecycles. The “amount of recycled material” and “amount of recyclable material” factors would incentivize the use of sustainable materials in product composition, reducing reliance on virgin resources and promoting a circular economy. The “biodegradable composition” factor would highlight products that can naturally decompose, reducing landfill waste and minimizing environmental impact.

The environmental rating system would provide a standardized way to assess the environmental performance of products, making it easier for consumers to compare different options. The environmental rating would increase transparency about the environmental impact of products, holding manufacturers accountable for their practices. The environmental rating would encourage manufacturers to adopt eco-design principles, focusing on minimizing environmental impact throughout the product lifecycle. The pursuit of higher environmental ratings would drive innovation in sustainable materials, manufacturing processes, and product design. By promoting longevity, repairability, reuse, and recyclability, the environmental rating would contribute to a circular economy where resources are kept in use for as long as possible. The focus on recycled and recyclable materials would reduce the need for extracting virgin resources, conserving natural resources, and minimizing environmental impact.

The online social network enables users to share firsthand experiences, tips, and advice about products, creating a rich and dynamic knowledge base that goes beyond manufacturer specifications. Information can be updated quickly and easily by the community, ensuring that the information is current and relevant. This is especially valuable for information like longevity of use and repairability, which can change over time. Users can connect with others who have similar interests and needs, leading to more personalized product recommendations and advice. The social network can promote transparency about product lifecycles, environmental impact, and repairability, holding manufacturers accountable. The interactive nature of a social network can foster greater engagement and participation from users, leading to a more comprehensive and valuable information resource. The social network can facilitate collective action, such as organizing repair workshops, sharing repair resources, or advocating for more sustainable product design. The social network can be a valuable resource for information on niche or older products that might not be well-documented on traditional websites. The social network can facilitate the exchange or donation of used electronics, promoting a circular economy.

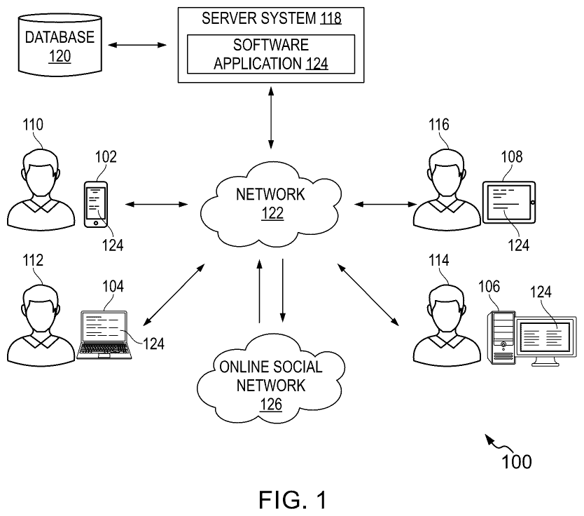

Various embodiments of the methods and systems for facilitating environmentally conscious ownership of electronic products by users are described hereinafter with reference to FIG. 1 to FIG. 7.

FIG. 1 is an example representation of an environment 100 related to at least some embodiments of the present disclosure. Although the environment 100 is presented in one arrangement, other embodiments may include the parts of the environment 100 (or other parts) arranged otherwise depending on, for example, the way in which a server system 118 (interchangeably referred to as “system 118”) facilitates environmentally conscious ownership of electronic products by users. The example representation of the environment 100 generally includes a plurality of electronic devices 102, 104, 106, and 108 (hereafter also collectively referred to as “the plurality of electronic devices 102-108”) associated with a plurality of users 110, 112, 114, and 116, respectively, a server system 118, and a database 120 connected to, and in communication with (and/or with access to) a wireless communication network (e.g., a network 122). The plurality of users 110, 112, 114, and 116 (hereafter also collectively referred to as “the plurality of users 110-116”) together form a social network as will be discussed in the following discussion.

In the illustrated environment 100, the plurality of electronic devices 102-108 are depicted as a mobile phone, a laptop, a desktop computer, and a tablet respectively. However, the plurality of electronic devices 102-108 may include any other suitable electronic or computing device as well. For instance, the computing device may be, for example, a smartphone, a personal computer, an electronic tablet, a wearable device, a smart device such as a smart TV or smart appliance, etc.

The server system 118 is embodied in at least one computing device in communication with the network 122 and/or embodied in at least one non-transitory computer-readable media. For example, the server system 118 may be deployed as a standalone server or can be implemented in the cloud as software as a service (Saas). The server system 118 provides or hosts a recommendation application 124 (interchangeably referred to as “software application 124”) for enabling the plurality of users 110, 112, 114, and 116 to receive purchase recommendations within large product collections. The software application 124 is a set of computer-executable codes configured to provide user interfaces (UIs) enabling the plurality of users 110-116 to be provided with environmentally sustainable purchase recommendations corresponding to a user request that would include at least one product category. Furthermore, in several embodiments, individual instances of the software application 124 are accessible to the plurality of electronic devices 102-108 for download and installation, as shown in the environment 100 in FIG. 1.

For example, the software application 124 may be a mobile application, a desktop application, a website, or a plugin in a third-party application (such as a browser application, a word processor application, a spreadsheet application, and the like). Furthermore, the third-party application may be any existing application facilitating the execution of tasks similar to that performed by the server system 118. In some embodiments, the software application 124 can be implemented as operating system extensions, modules, plugins, and the like. This enables the plurality of users 110-116 to be able to access the server system 118 on the plurality of respective electronic devices 102-108. In another embodiment, the software application 124 may be factory-installed on the plurality of electronic devices 102-108. However, even during factory installation, it is envisaged that the software application 124 is provided by the sever system 118 for download and installation in the plurality of electronic devices 102-108.

In addition to accessing the system 118, the individual instances of the software application 124 allow the plurality of electronic devices 102-108 to configure an online social network 126 of users where the plurality of users 110-116 can communicate with each other and exchange information, documents, media files, etc. amongst the plurality of electronic devices 102-108 and the server system 118. In several embodiments, any one or more of the plurality of electronic devices 102-108 can replace the server system 118 to enable peer-to-peer social networking between the plurality of electronic devices 102-108 and the plurality of users 110-116.

Further, the software application 124 may be operative in a cloud infrastructure, or the software application 124 may be executed within or as a virtual machine (VM), virtual server, or within a container that may be managed in the cloud infrastructure. In the cloud-based infrastructure, software application 124 may not need to be installed locally in the plurality of electronic devices 102-108 to configure the online social network 126. In several embodiments, the cloud-based implementation of the software application 124 may follow a single tenancy where individual instances of the software application 124 may be installed and assigned to the plurality of users 110-116 accessing the cloud infrastructure through the plurality of respective electronic devices 102-108. In several alternate embodiments, the software application 124 may be configured as a multi-tenant application where at least one instance of the software application 124 installed with the server system 118 may allow the online social network 126 to be configured using multi-tenancy. In such a scenario as well, the online social network 126 of users may be configured, where the plurality of users 110-116 can communicate with each other and exchange information, documents, media files, etc. amongst the plurality of electronic devices 102-108 and the server system 118.

In one example, the server system 118 may be configured to provide personalized purchase recommendations to one or more of the plurality of users 110-116. Each user may be configured to receive tailored purchase recommendations based on their individual preferences and product categories. For instance, the server system 118 may receive product information related to a plurality of electronic products owned by one or more second users (for example, users 112-116, hereinafter also referred to as “one or more second users 112-116”) from one or more respective electronic devices (for example, the electronic devices 104-108, hereinafter also referred to as “one or more second electronic devices 104-108”) associated with the one or more second users 112-116, assign an environmental rating to each one of the plurality of electronic products based, at least in part, on the product information, assign or determine one or more product categories, to or for each one of the plurality of electronic products, based, at least in part, on respective product information.

The system 118 may then generate and provide one or more purchase recommendations for another user (for example, the user 110, hereinafter also referred to as “the first user 110”) based at least on the assigned environmental ratings and one or more product categories. The one or more purchase recommendations may be provided on at least one electronic device associated with the first user 110 (for example, the electronic device 102, hereinafter also referred to as “at least one first electronic device 102”). The product information, in that regard, may include a make, a model, a year of manufacture, technical specifications, etc. for each one of the plurality of electronic products owned by the one or more second users 112-116. The system 118 may further, as will discussed in detail in the following discussion, enable the first user 110 to exchange one or more of text messages or multi-media messages with the one or more second users 112-116, through the online social network 126. The text or the multi-media messages would enable the first user 110 to solicit further information on the one or more purchase recommendations while also engaging in discussions and providing feedback.

The system 118, in the process of generating the one or more purchase recommendations, may also receive from the one or more second users 112-116, usage information and repair history of each electronic product of the plurality of electronic products. The usage information and the repair histories may be provided by the one or more second users 112-116 via the one or more respective second electronic devices 104-108. The system 118 may also be configured to determine, for each electronic product of the plurality of products, one or more of longevity of use by different users on the online social network 126, a possibility of repairing after malfunction, amount of recycled material used in composition, amount of recyclable material used in the composition, or a biodegradable composition, from one or more of the respective product information, the respective usage information, or the respective repair history.

The server system 118 may further be configured to determine the environmental rating for each electronic product of the plurality of electronic products based, at least in part, on the respective usage information and the respective repair history, in addition to the product information. In either of the scenarios, the one or more environmental ratings associated with the one or more purchase recommendations may be displayed on a user interface generated by at least one instance of the software application 124, at the at least one first electronic device 102.

It should be noted that the number of users and electronic devices described herein are only used for exemplary purposes and do not limit the scope of the disclosure. The disclosure applies to any finite number of individuals or groups of users acting as the one or more second users providing product-related information, and any finite number of individuals or groups of users acting as the first user seeking purchase recommendations based on several different possible product categories.

The database 120 may be configured in one or more storage devices with non-volatile memory such as flash memory, Erasable Programmable Read-Only Memory (EPROM), Electrically Erasable Programmable Read-Only Memory (EEPROM) located at a centralized location such as a cloud computing facility, or may be distributed database configured in several storage devices across several locations for redundancy. In several embodiments, the database 120 may be maintained in a Network Associated Storage (NAS) or a Storage Area Network (SAN). The database 120 may be configured to store user data such as usernames, passwords, names, contact details, profile pictures, and other details provided by the plurality of users 110-116. Furthermore, the database 120 may store user-generated content such as posts, comments, photos, videos, links, and other content shared by the plurality of users 110-116.

The database 120 may also store relationships and connections such as friendships, followers, groups, and communities. The database 120 may further be configured to store data on user interactions with content, such as likes, shares, comments, and reactions. Furthermore, activity logs including logins, posts, profile updates, and other actions may also be stored in the database 120. Also, stored in the database 120 may be user preferences for privacy, notifications, and other settings. The database 120 may also store information related to the online social network 126 as well, which may further include features, functionalities, and content, and administrative data such as data related to user management, content moderation, and other administrative tasks.

It is to be noted here that the database 120 is a representative term for one or more instances of one or more types of databases associated with the server system 118. The types of databases represented by the database 120 may include relational databases, document databases, graph databases, key-value databases, and the like. Several combinations of different kinds of databases may be used for managing the online social network 126. For example, relational databases are ideal for information that has a standardized, consistent structure. Examples of such information may include first name, last name, phone number, address, etc. Examples of relational databases include MySQL, PostgreSQL, and Microsoft SQL Server. A document database stores unstructured data that does not fit into traditional relational databases. Document databases may be useful for user-generated social data like user chat messages, comments, photos, and videos. Examples of document databases include MongoDB, Firebase Realtime Database, and CouchDB.

A graph database stores data as connections. Graph databases may be useful for data that has complex relationships, e.g., friends, followers, likes, and shares on the online social network 126. The graph databases would enable the generation of recommendations for new friends, pages, or products. Examples of graph databases include NebulaGraph, Neo4j, ArangoDB, and OrientDB. A key value database stores data that has unique identifiers, e.g., time stamps. In the context of the online social network 126 or the software application 124, these identifiers or keys can be login sessions or notification preferences. Examples of key-value databases include Redis, DynamoDB, and Memcached.

The network 122 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 122 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, any future communication protocol, or any combination thereof. The network 122 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof. For example, the network 122 may include multiple different networks, such as a private network made accessible by the electronic devices 102-108, the server system 118, and the database 120 separately, and/or a public network (e.g., the Internet) through which the electronic devices 102-108, the server system 118, and the database 120 may communicate.

The number and arrangement of systems, devices, and/or networks shown in FIG. 1 are presented as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 118 should be understood to be embodied in at least one computing device in communication with the network 122, which may be specifically configured, via executable instructions, to perform steps as described herein, and/or embodied in at least one non-transitory computer-readable media.

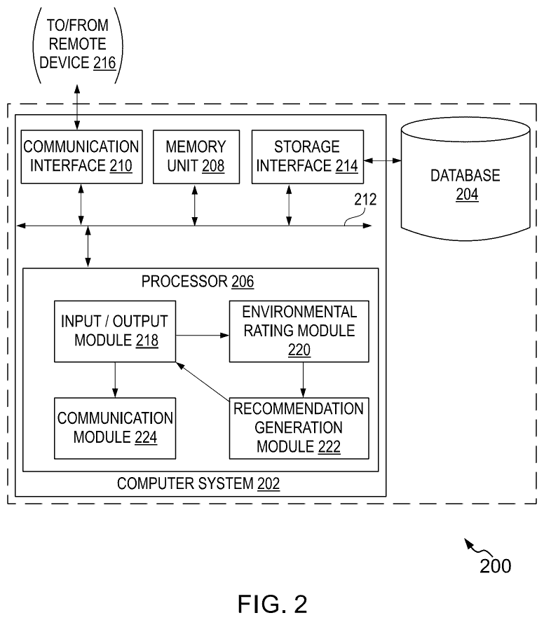

FIG. 2 is a simplified block diagram representation of a server system 200, in accordance with an embodiment of the present disclosure. The server system 200 is an example of the server system 118 depicted in FIG. 1. In some embodiments, the server system 200 is embodied as a cloud-based and/or SaaS-based (software as a service) architecture. The server system 200 is configured to facilitate managing environmental impact during the lifecycle of an electronic product. The server system 200 includes a computer system 202 and a database 204. The database 204 is an example of the database 120 of FIG. 1. The computer system 202 includes at least one processor 206 (hereinafter referred to as “processor”) for executing instructions, a memory 208, a communication interface 210, and a storage interface 214 that communicate with each other via a bus 212.

In some embodiments, the database 204 is integrated into the computer system 202. For example, the computer system 202 may include one or more hard disk drives as the database 204. In one embodiment, the database 204 is integrated within the computer system 202 and configured to store an instance of the recommendation application 124. Further, the storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 may include a user database and a product database. Moreover, the product database stores the product profiles of all the products that can be recommended.

The processor 206 includes suitable logic, circuitry, and/or interfaces to execute computer-readable instructions for performing one or more operations for facilitating environmentally conscious ownership of electronic products by users (such as the plurality of users 110-116). Examples of the processor 206 include but are not limited to, a microcontroller, a microprocessor, a general-purpose processor, an application-specific integrated circuit (ASIC) processor, a reduced instruction set computing (RISC) processor, a complex instruction set computing (CISC) processor, a field-programmable gate array (FPGA), and the like. The memory unit 208 includes suitable logic, circuitry, and/or interfaces to store a set of machine-readable instructions for performing operations. Examples of the memory unit 208 include but are not limited to, a random-access memory (RAM), a read-only memory (ROM), a removable storage drive, a hard disk drive (HDD), and the like. It will be apparent to a person skilled in the art that the scope of the disclosure is not limited to realizing the memory unit 208 in the server system 200, as described herein. In another embodiment, the memory unit 208 may be realized in the form of a database server or cloud storage working in conjunction with the server system 200, without departing from the scope of the present disclosure.

The processor 206 is operatively coupled to the communication interface 210 such that the processor 206 is capable of communicating with a remote device 216 such as the plurality of electronic devices 102-108, or with any entity connected to the network 122 (as shown in FIG. 1). In an embodiment, the processor 206 is configured to facilitate the software application 124 on the plurality of electronic devices 102-108 for enabling a plurality of functionalities to the devices described in the disclosure.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

Further, in an embodiment, the server system 200 includes an input/output (I/O) module 218, an environmental rating module 220 (interchangeably referred to as “module 220”), a recommendation generation module 222, and a communication module 224. The I/O module 218, the environmental rating module 220, the recommendation generation module 222, and the communication module 224 are envisaged to be enabled at least in part by the software application 124 installed in the computer system 202. The machine-readable instructions coded in the software application 124 may be stored in the memory unit 208 and executed by the processor 206, during run-time to at least partially enable the I/O module 218, the environmental rating module 220, the recommendation generation module 222, and the communication module 224.

It should be noted that components, described herein, can be configured in a variety of ways, including electronic circuitries, digital arithmetic and logic blocks, and memory systems in combination with software, firmware, and embedded technologies. For example, the modules 218, 220, 222, and 224 can be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The communication module 224 is configured to facilitate data exchange between the server system 200 and external devices or networks.

The I/O module 218 is configured to enable the plurality of electronic devices 102-108, including the at least one first electronic device 102 and the one or more second electronic devices 104-108, to access at least one instance of the software application 124. For example, the I/O module 218 may enable the at least one first electronic device 102 and the one or more second electronic devices 104-108 to download respective individual instances of the software application 124. In that regard, the software application 124 may be made available by the I/O module 218 in an application store through publication, from where the software application 124 can be downloaded and installed in the plurality of electronic devices 102-108. Alternately, or in addition, the I/O module 218 may make the software application 124 available through a web-based Uniform Resource Locater (URL), where the plurality of users 110-116 can visit the URL and direct download and install the software application 124 in the plurality of respective electronic devices 102-108.

The software application 124 may also be installed in one or more of the plurality of electronic devices 102-108 through package managers, for example, ‘apt’ for the Linux operating system and ‘Chocolatey’ for the Windows operating system. Package managers simplify software management and ensure that all dependencies are met. Package managers also provide a consistent way to install and update software. In several scenarios, the plurality of electronic devices 102-108 may be associated with an organization that may leverage enterprise deployment tools to distribute and install the software application 124 in the plurality of electronic devices 102-108 through a local network. Enterprise deployment tools allow for centralized management of software installations and updates.

In several alternate embodiments, the several instances of the software application 124 may be installed in the computer system 202 in cloud infrastructure, and the I/O module 218 may be configured to provide access to the individual instances of the software application 124 to the plurality of users 110-116 through the plurality of respective electronic devices 102-108. In several alternate embodiments, at least one instance of the software application 124 may be installed with the computer system 202 as a multi-tenant application, the I/O module 218 may provide access to the at least one instance of the software application 124 to the plurality of electronic devices 102-108. In either of the scenarios, the cloud-based instances of the software application 124 may be accessed by the plurality of users 110-116, through one or more of web browsers, dedicated client applications, virtual desktop infrastructures, mobile applications, and the like. Thus, by enabling the plurality of electronic devices 102-108, including the at least one first electronic device 102 and the one or more second electronic devices 104-108, to access at least one instance of the software application 124, the I/O module 218 allows the at least one first electronic device 102 to connect with the one or more second electronic devices 104-108, to configure the online social network 126 of the plurality of users 110-116.

The I/O module 218 is further configured to receive product information related to a plurality of electronic products owned by one or more second users 112-116. In that regard, the product information is provided by the one or more second users 112-116 through one or more respective second electronic devices 104-108. The product information, for example, may include name and model numbers of the electronic products, name of the company that produces the respective electronic product, images showcasing the electronic products from different angles, cost, year of manufacture, etc. The product information may also include technical specifications of the respective electronic product.

For example, the technical specifications may include size dimensions and weight, power requirement specifications such as voltage, and wattage, performance details such as efficiency and heating/cooling capacity for electrical appliances, and brightness/resolution for TVs or smartphones. The technical specifications may also include materials used in the construction of the respective products. In addition, the product information may also provide warranty details and customer support information such as contact numbers, websites for troubleshooting, etc. for the respective product. In several embodiments, the I/O module 218 may further be configured to receive at least a part of product information for one or more of the plurality of electronic products from online web sources including manufacturer websites, product registration agencies, product certification agencies, online e-commerce platforms, product review platforms, and the like.

The I/O module 218 may further receive usage information and repair history of each electronic product of the plurality of electronic products. In that regard, the usage information and the repair histories for the plurality of electronic products may be provided by the one or more second users 112-116 through the one or more second electronic devices 104-108. The usage information, for instance, can encompass a range of data points, offering insights into how the device has been utilized over time. This information can be valuable for various purposes, from understanding individual usage patterns to identifying potential issues or optimizing energy consumption. For example, usage information may include records of when the electronic product was turned on and off, including timestamps and durations. This can help track how frequently the electronic product is used and for how long. If the electronic product has different operating modes (e.g., low power, high performance), the history might log which modes were used and when.

For electronic products with multiple features, the usage information could track which features were used and how often. The usage information may further include records of any errors or malfunctions that occurred, including error codes and timestamps. This can be crucial for troubleshooting and identifying potential issues. For energy-efficient appliances, the usage information might track energy usage over time, providing insights into consumption patterns and potential savings. Logs of any maintenance performed on the electronic product, such as filter changes or repairs. This can help track the preventive maintenance history of the electronic product.

Furthermore, the repair histories provide a valuable record of maintenance and repairs performed on the electronic products throughout their lifespan. The repair histories would typically include comprehensive logs of each service event, offering insights into the reliability and potential recurring issues regarding the plurality of electronic products. For instance, the repair histories may include any one or more of (1) dates when the repair services were performed, (2) clear and concise descriptions of the issues that prompted the repairs, including any error codes displayed or symptoms observed, (3) diagnoses of the root cause of the problems, including the specific components or systems affected, (4) lists of all parts that were replaced during the repairs, including part numbers and descriptions, (5) information about the labor involved in the repairs, including the time spent, (6) total costs of the repairs, including parts, labor, and any other associated fees, (7) if the repair was covered under warranty, the details of the warranty claim, including the warranty provider and claim number, or (8) name and contact information of the service centers or technicians who performed the repair.

Once the information in different forms and volumes has been received from the one or more second electronic devices 104-108 by the I/O module 218, the environmental rating module 220 (or “module 220”) is configured to determine an environmental rating for each one of the plurality of electronic products based on the information received by the I/O module 218. It is further envisaged that for determining the environmental rating, the module 220 may determine for each product one or more of longevity of use by different users on the online social network 126, a possibility of repairing after malfunction, amount of recycled material used in composition, amount of recyclable material used in the composition, or a biodegradable composition. For instance, analyzing power on/off cycles, operating modes, and feature usage over time can provide a strong indication of how frequently and intensively an electronic product is used. Higher usage generally suggests a shorter lifespan due to increased wear and tear.

Frequent repairs, especially for the same issue, can indicate an electronic product nearing the end of its functional life. The types of repairs and parts replaced can also provide clues about the durability and expected lifespan of an electronic product. Manufacturer warranties and stated expected lifespan (if available) offer a baseline for longevity. However, real-world usage and maintenance heavily may influence the actual lifespan. A detailed repair history with information on parts replaced and labor involved indicates the feasibility and cost of repairs. Frequent repairs with readily available parts suggest good repairability. The availability of repair manuals, spare parts, and authorized service centers indicates the manufacturer's commitment to repairability. Error logs and the nature of malfunctions can highlight potential design flaws that might make repairs challenging or costly in the long run. Information on recycled and recyclable materials used in the product composition is often provided by manufacturers. In addition, further information is provided through certifications or labels that indicate the use of sustainable materials. Furthermore, manufacturers may explicitly state if the product or its components are biodegradable.

Furthermore, the module 220 may further be configured to quantify or assign a score to factors such as the longevity of use by different users on the online social network 126, the possibility of repair after a malfunction, the amount of recycled material used in composition, the amount of recyclable material used in the composition, or the biodegradable composition. For instance, to quantify longevity, points may be assigned to each electronic product based on the duration of use before significant performance decline or irreparable failure. The frequency and nature of repairs may be considered negative points, reducing the overall longevity score. Manufacturer warranty and expected lifespan may be incorporated as baseline points. In another example, the average lifespan may be determined based on usage and repair data and compared with industry benchmarks or similar products to determine relative longevity.

In addition, to quantify repairability, points may be assigned for the availability of repair manuals, spare parts, and authorized service centers. Complexity and cost of repairs based on repair history may be factored into the quantification. The availability of DIY repair resources and communities may also be considered. In another example, the average repair cost and frequency for an electronic product may be determined from repair history or a repairability index may be developed based on the availability and accessibility of repair resources. For quantifying recycled or recyclable materials, points may be assigned based on the percentage of recycled and recyclable materials used in the composition of the electronic product. The presence of hazardous materials may be regarded as a negative point. Furthermore, the ease of disassembly and material separation for recycling may also be factored in. In another example, manufacturer-provided data or third-party assessments may be used to determine the exact percentage of recycled/recyclable content, and a material sustainability index may be developed based on the overall composition and recyclability.

Furthermore, to quantify biodegradability, points may be assigned for the use of biodegradable materials in the composition of the electronic product. The time taken for the materials to decompose and the environmental impact of the decomposition process may also be considered. In another example, standardized tests and certifications may be used to determine the biodegradability of materials. Also, a biodegradability index may be developed based on the percentage of biodegradable content and its decomposition characteristics. By combining these scoring and quantization methods, it is possible to create a comprehensive sustainability profile for the plurality of electronic products. To determine the environmental rating for an electronic product, the quantified values of various environmental factors may be combined into a single, comprehensive score.

For example, the module 220 may (1) define weights for each environmental factor, (2) normalize quantified values, (3) calculate weighted scores, and (4) sum weighted scores to generate the environmental rating. For example, longevity and recyclability might be given higher weights than the amount of recycled material used, reflecting their greater impact on overall environmental performance. The quantified values for each factor may be normalized to a common scale (e.g., 0 to 100) to allow for meaningful comparison and aggregation. The normalized value of each factor may be multiplied by its corresponding weight to obtain a weighted score for that factor. The weighted scores for all factors may be added to arrive at the overall environmental rating. An example determination of the environmental rating for an electronic product has been presented in Table 1.

TABLE 1

| | | | Normalized | | |
|---|---|---|---|---|---|
| S. | Environmental | Quantified | Value | | Weighted |
| No. | Factor | Value | (0-100) | Weight | Score |
| 1 | Longevity of Use | 5 years | 60 | 0.3 | 18 |
| 2 | Possibility of | High | 80 | 0.25 | 20 |
| | Repair | | | | |
| 3 | Recycled Material | 10% | 40 | 0.15 | 6 |
| | Used | | | | |
| 4 | Recyclable | 80% | 80 | 0.2 | 16 |
| | Material Used | | | | |
| 5 | Biodegradable | N/A | 0 | 0.1 | 0 |
| | Composition | | | | |

| | | |
|---|---|---|
| Environmental Rating | 1 | 60 |

In this manner, the environmental rating may be calculated for each of the plurality of products owned by the one or more second users 112-116 and stored in the database 204 for further reference.

The I/O module 218 may further receive a product category for purchase by the first user 110. The product category, in that regard, would be received from the at least one first electronic device 102. The received product category may, for example, indicate a product type, such as “refrigerator”, “laptop”, “smartphone”, “television”, etc. The received product category may also indicate a brand name, such as “Samsung Refrigerator”, “Apple iPhone”, “Sony Television”, etc. The received product category may alternately or additionally indicate desired features, such as “Smart TV with voice control”, “refrigerator with ice maker”, “laptop with dedicated graphics card”, etc. In several embodiments, the product category may indicate technical specifications, such as “55-inch TV”, “1 Tb laptop, “256 GB smartphone”, etc. Furthermore, in several embodiments, the product category may indicate a use case, such as “gaming laptop”, “office printer”. In addition, product categories may also indicate price range, connectivity options, size and dimensions, etc.

In that regard, the recommendation generation module 222 may be configured to identify the electronic products pertaining to the received product category by accessing one or more of the product information, the usage information, or the repair histories, of the plurality of products, stored in the database 204. Furthermore, the recommendation generation module 222 is configured to access the environmental ratings of the identified electronic products from the database 204. The recommendation generation module 222 may then generate one or more purchase recommendations for the first user 110 based at least on the accessed environmental ratings. For example, the electronic products, for the received product category, with top five, ten, or fifteen environmental ratings may be included in the one or more purchase recommendations. Further, the one or more purchase recommendations may be sorted in ascending or descending order based on their respective environmental ratings.

The one or more purchase recommendations once generated may be presented to the first user 110, by the I/O module 218 through the at least one first electronic device 102. The one or more purchase recommendations may be presented in the form of an audio output, a display output, or an audiovisual output by the I/O module 218. In several embodiments, the I/O module 218 may also be configured to display one or more environmental ratings associated with the one or more purchase recommendations, on a user interface generated by at least one instance of the software application 124, at the at least one first electronic device 102. In addition, the I/O module 218 may be configured to allow the first user 110 to further refine their search by specifying additional preferences, such as price range, brand, specific features, size and dimensions, etc. Furthermore, color-coded ratings or badges may be provided in the user interface to quickly convey environmental performance. Furthermore, the I/O module 218 may allow the first user 110 to access detailed product information, including:
Breakdown of the environmental rating (e.g., scores for longevity, repairability, recycled content, etc.)
Technical specifications
User reviews
Links to retailer websites

In an example scenario, the first user 110 searches for “laptops.” The system filters the database for laptops and sorts them by their environmental rating. The top recommendations might be:
Laptop A: Environmental rating: 90/100. Made with 50% recycled materials, highly repairable, and energy-efficient.
Laptop B: Environmental rating: 85/100. Long lifespan, modular design for easy repairs, and uses sustainable packaging.
Laptop C: Environmental rating: 80/100. Energy Star certified, made with recyclable materials, and offers a trade-in program for responsible disposal.

The first user 110 can then further refine their search by specifying preferences like price range or screen size, or they can click on a product to view more detailed information. In addition, the I/O module 218 may further provide to the at least one first electronic device 102, brief explanations of the environmental factors considered in the rating to help users understand the recommendations. Furthermore, the I/O module 218 may further provide to the at least one first electronic device 102, the methodology used to generate the environmental ratings to maintain user trust. Furthermore, database 204 may be regularly updated by the processor 206 to ensure recommendations are current and accurate.

The communication module 224 is configured to enable the at least one first electronic device 102 to exchange one or more of text messages or multi-media messages with the one or more second electronic devices 104-108, through the online social network 126. In that regard, the communication module 224 may work in conjunction with the I/O module 218 to enable the exchange of one or more of the text messages or the multi-media messages. For example, the I/O module 218 may generate the user interface to receive text input, multi-media input, audio input, and video input, from one electronic device (for example, the at least one electronic device 102), the communication module 224 may receive the text, the multi-media, the audio, and the video inputs and process them for delivery to another electronic device (for example, the one or more second electronic devices 104-108). In that regard, the communication module 224 and the I/O module 218 may leverage real-time communication protocols. The real-time communication protocols are designed to establish persistent connections between the plurality of electronic devices 102-108 and the server system 200, allowing for instant message delivery. Examples of real-time communication protocols include WebSockets, XMPP, etc. The server system 200 may act as a central hub for managing message delivery, ensuring reliability and security.

Furthermore, the communication module 224 may leverage message queues to temporarily store messages on the server system 200 before the messages are delivered. This ensures messages are not lost in case of temporary network issues or if the recipient is offline. Messages may further be stored in the database 204, allowing the plurality of users 110-116 to access their message history. Different storage mechanisms might be used for text messages and multimedia messages (e.g., separate databases or cloud storage for media files). In several embodiments, Content Delivery Networks (CDNs) may be used to efficiently deliver multimedia content (images, videos) to the plurality of users 110-116, reducing latency and improving performance. Furthermore, CDNs store copies of media files on servers distributed around the world, allowing the plurality of users 110-116 to download them from the closest server. In addition, the I/O module 218 and the communication module 224 may also enable audio and video calling. For audio calling, voice data is encoded and transmitted in real-time using protocols like WebRTC, SIP, or RTP. For video calling, video data, along with audio, is transmitted using similar protocols, often with added features for video encoding and decoding.

Although FIG. 2 shows the hardware elements of the server system 200, it is to be understood that other embodiments are not limited thereon. In other embodiments, the server system 200 may include fewer or a greater number of elements. Further, the labels or names of the elements are used only for illustrative purposes and do not limit the scope of the disclosure. One or more components can be combined to perform the same or substantially similar function.

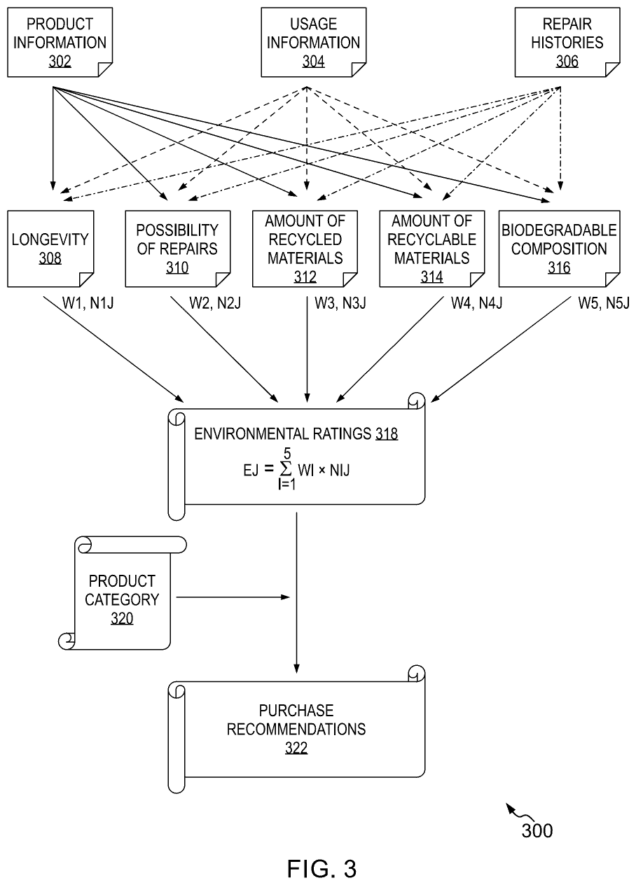

FIG. 3 illustrates a block diagram 300 illustrating the flow of information for facilitating environmentally conscious ownership of electronic products by users, in accordance with an embodiment of the present disclosure. Product information 302 for each one of the plurality of electronic products owned by the one or more second users 112-116, is received from the one or more second electronic devices 104-108 and several online resources such as manufacturer websites, registration agencies, certifying agencies, merchant websites, and e-commerce platforms. The product information 302 may include details like brand, model, technical specifications, warranty information, and more.

Usage information 304 and repair histories 306 for the plurality of electronic products are received from the one or more second electronic devices 104. The usage information 304 may include power cycles, operating modes, feature usage, error logs, and energy consumption patterns. The repair histories 306 may include details about repairs, including dates, descriptions of issues, diagnoses, parts replaced, labor involved, costs, warranty information, and service providers.

Furthermore, the environmental factors for each one of the plurality of electronic products are determined from one or more of the product information 302, the usage information 304, or the repair histories 306. The environmental factors include one or more of longevity 308 of use by different users on the online social network 126, a possibility of repair 310 after a malfunction, amount of recycled material 312 used in composition, amount of recyclable material 314 used in the composition, or a biodegradable composition 316.

The environmental factors may then be quantified using several techniques discussed in the aforementioned description. Furthermore, respective weights W1, W2, W3, W4, and W5, may be assigned to the enlisted five example environmental factors. It is to be noted here that there may be more than five or less than five environmental factors in several alternate scenarios, and the number of weights may vary accordingly. The quantified values of the environmental factors for each electronic product of the plurality of electronic products may be normalized for a uniform comparison. The normalized values may be indicated as N1J, N2J, N3J, N4J, N5J, where ‘J’ represents an identification of an individual electronic product. Therefore, the environmental rating EJ for Jth electronic product may be given by equation (1).

$$EJ = {\sum }_{I = 1}^{5} WI \times NIJ \qquad ( 1 )$$

After environmental ratings 318 for each one of the plurality of electronic products is determined, the environmental ratings 318 may be stored in the database 120 or 204. On receipt of a product category 320, for purchase by the first user 110, from the at least one electronic device 102, one or more purchase recommendations 322 may be generated for the received product category 320 based on the environmental ratings 318. The one or more purchase recommendations 322 may be prioritized by highlighting products with the highest environmental scores, enabling users to make informed purchasing decisions that align with their environmental preferences.

There are several advantages to the approach presented in the aforementioned paragraphs. The environmental ratings 318 would provide the consumer with clear and concise information about the environmental impact of their purchasing decisions. This would allow the consumers to make more informed choices and support companies that prioritize sustainability. The choice of products with higher environmental ratings 318 would create market pressure for eco-friendly practices. The “longevity of use” factor would reward products designed for durability and repairability, discouraging planned obsolescence and promoting a “repair, reuse, recycle” mindset. Including the “possibility of repairing” factor would push manufacturers to design products that are easier and more affordable to fix, reducing waste and extending product lifecycles. The “amount of recycled material” and “amount of recyclable material” factors would incentivize the use of sustainable materials in product composition, reducing reliance on virgin resources and promoting a circular economy. The “biodegradable composition” factor would highlight products that can naturally decompose, reducing landfill waste and minimizing environmental impact.

The environmental rating system would provide a standardized way to assess the environmental performance of products, making it easier for consumers to compare different options. The environmental ratings 318 would increase transparency about the environmental impact of products, holding manufacturers accountable for their practices. The environmental ratings 318 would encourage manufacturers to adopt eco-design principles, focusing on minimizing environmental impact throughout the product lifecycle. The pursuit of higher environmental ratings 318 would drive innovation in sustainable materials, manufacturing processes, and product design. By promoting longevity, repairability, reuse, and recyclability, the environmental ratings 318 would contribute to a circular economy where resources are kept in use for as long as possible. The focus on recycled and recyclable materials would reduce the need for extracting virgin resources, conserving natural resources, and minimizing environmental impact.

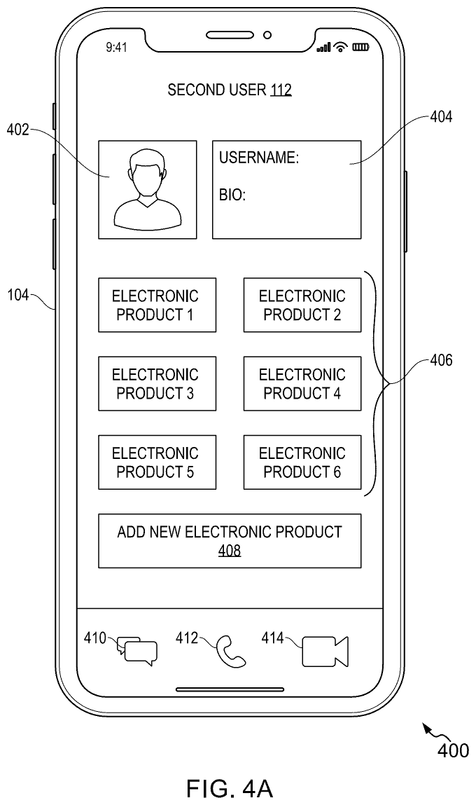

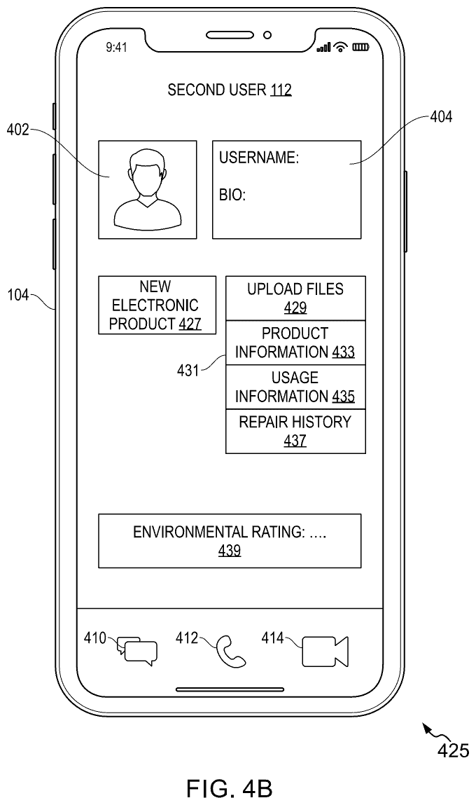

FIG. 4A illustrates a user interface 400 for the second user 112, on the second electronic device 104, in accordance with an embodiment of the present disclosure. The user interface 400 depicts a profile picture 402 of the second user 112, on the top-left side of the user interface 400. In addition, the user interface 400 depicts profile information 404 of the second user 112. The profile information 404 may include details such as username, address, date of joining the online social network 126, number of connections, brief biography, and the like. The user interface 400 also depicts links or keys 406 for accessing details of several electronic products owned by the second user 112. In the lower portion of the user interface 400, there is a link or key 408 indicating “ADD NEW ELECTRONIC PRODUCT”, that enables the second user 112 to add a new electronic product in their profile. Furthermore, at the bottom portion of the user interface 400, there are provided three keys, a text messaging key 410, an audio call key 412, and a video call key 414. In either of the scenarios, the keys depicted in user interface 400 or other interfaces discussed in the following discussion, maybe hardware-based keys or software-implemented keys.

FIG. 4B illustrates another user interface 425 for the second user 112, on the second electronic device 104, in accordance with an embodiment of the present disclosure. The user interface 425 is activated when the second user 112 presses the “ADD NEW ELECTRONIC PRODUCT” key 408. The user interface 425 depicts a label 427 for the new electronic product being added to the profile of the second user 112. In addition, there is another “UPLOAD FILES” key 429 for uploading files related to the new electronic product being added to the profile of the second user 112. As the “UPLOAD FILES” key 429 is activated or pressed, a drop-down menu 431 drops below the key 429. The drop-down menu 431 lists three categories of documents that may be uploaded, which include product information 433, usage information 435, and repair history 437. As the documents are being uploaded, an environmental rating block 439 of the user interface 425 illustrates that the environmental rating of the new product being added is determined in real-time.

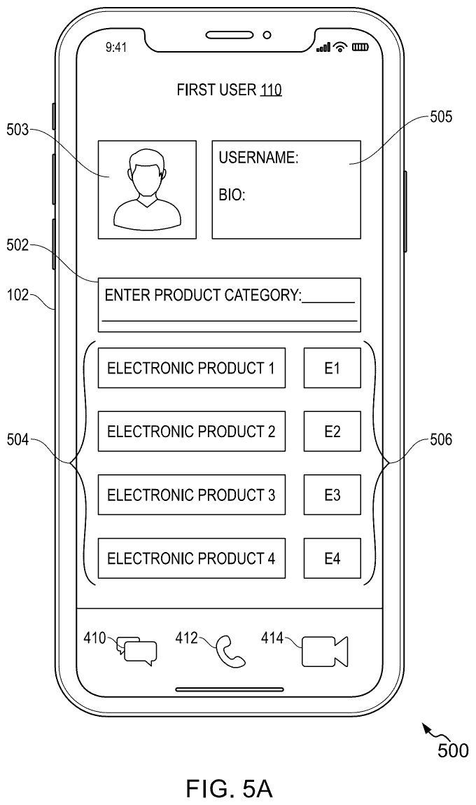

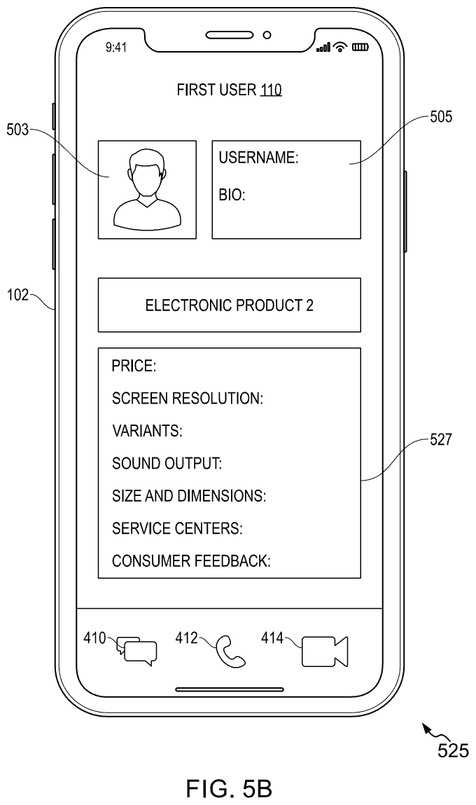

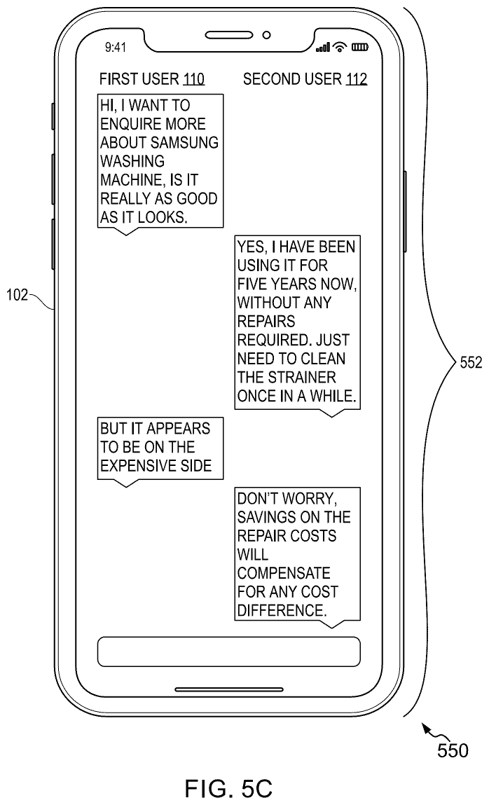

FIG. 5A illustrates a user interface 500 for the first user 110, on the at least one first electronic device 102, in accordance with an embodiment of the present disclosure. The user interface 500 depicts a profile picture 503 and profile information 505 of the first user 110. Furthermore, FIG. 5A depicts a product category field 502 for entering the product category. Once the product category is entered by the first user 110 in the product category field 502, a list of electronic products 504 with corresponding environmental ratings 506 is displayed in the user interface 500. The user interface 500 also depicts the text messaging key 410, the audio call key 412, and the video call key 414.

FIG. 5B illustrates another user interface 525 for the first user 110, on the at least one first electronic device 102, in accordance with an embodiment of the present disclosure. The user interface 525 is activated when the first user 110 selects “ELECTRONIC PRODUCT 2” from the list of electronic products 504. Once selected, the user interface 525 displays additional details 527 pertaining to the second electronic product. The additional details may include, for example, a price, screen resolution (for example, for Televisions or smartphones), different variants available, sound output, locations and contact details of service centers, and consumer feedback for the selected electronic products. The first user 110 may further verify the details and feedback for the selected electronic product by activating any one or more of the text messaging key 410, the audio call key 412, or the video call key 414. FIG. 5C illustrates another user interface 550 for the first user 110, on the at least one first electronic device 102, in accordance with an embodiment of the present disclosure. The user interface 550 depicts text-based communication 552 between the first user 110 and the second user 112 where the first user 110 is verifying details about a washing machine that the first user 110 is interested in.

As depicted in FIGS. 4A-5C, the online social network 126 enables users to share firsthand experiences, tips, and advice about products, creating a rich and dynamic knowledge base that goes beyond manufacturer specifications. Information can be updated quickly and easily by the community, ensuring that the information is current and relevant. This is especially valuable for information like longevity of use and repairability, which can change over time. Users can connect with others who have similar interests and needs, leading to more personalized product recommendations and advice. Furthermore, the online social network 126 can promote transparency about product lifecycles, environmental impact, and repairability, holding manufacturers accountable. Moreover, the interactive nature of the online social network 126 can foster greater engagement and participation from users, leading to a more comprehensive and valuable information resource. Furthermore, the online social network 126 can facilitate collective action, such as organizing repair workshops, sharing repair resources, or advocating for more sustainable product design. In addition, the online social network 126 can be a valuable resource for information on niche or older products that might not be well-documented on traditional websites. Also, the online social network 126 can facilitate the exchange or donation of used electronics, promoting a circular economy.

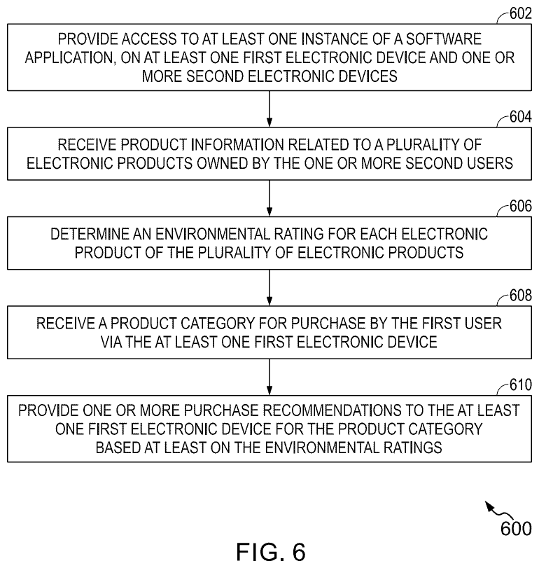

FIG. 6 illustrates a method 600 for facilitating environmentally conscious ownership of electronic products by users, in accordance with an embodiment of the present disclosure. The method 600 depicted in the flow diagram may be executed by, for example, the at least one server system such as the server system 118. Operations of the flow diagram of the method 600, and combinations of operations in the flow diagram of the method 600, may be implemented by, for example, hardware, firmware, a processor, circuitry, and/or a different device associated with the execution of software that includes one or more computer program instructions. The method 600 starts at Step 602.

At Step 602, the server system 118 provides access to at least one instance of the software application 124, to the at least one first electronic device 102, and the one or more second electronic devices 104-108. In that regard, the at least one first electronic device 102 and the one or more second electronic devices 104-108 may download individual instances of the software application 124 from the server system 118. Furthermore, the at least one first electronic device 102 and the one or more second electronic devices 104-108 may access the installed instances of the software application 124 to connect and exchange information with each other or with the server system 118. Alternately, the software application 124 may be a cloud-infrastructure-based application accessed under singular tenancies or as a multi-tenant application. In either of the scenarios, the at least one instance of the software application 124 enables the at least one first electronic device 102 to connect with the one or more second electronic devices 104-108, to configure an online social network 126 of users, such as the plurality of users 110-116. In several embodiments, the at least one instance of the software application 124 enables the at least one first electronic device 102 to exchange one or more of text messages or multi-media messages with the one or more second electronic devices 104-108, through the online social network 126.

At Step 604, the server system 118 receives product information related to a plurality of electronic products owned by the one or more second users 112-116. The product information is provided by the one or more second users 112-116 to the at least one instance of the software application 124 via the one or more respective second electronic devices 104-108. In several embodiments, the product information includes one or more of a make, a model, a year of manufacture, or technical specifications of a respective electronic product of the plurality of electronic products. In several embodiments, the server system 118 further receives usage information and repair history of each electronic product of the plurality of electronic products. The usage information and repair histories are provided by the one or more second users 112-116 via the one or more respective second electronic devices 104-108.

At Step 606, the server system 118 determines an environmental rating for each electronic product of the plurality of electronic products based, at least in part, on the respective product information. In several embodiments, the environmental rating for the respective electronic product is determined, by the server system 118, based, at least in part, on the usage information and the repair history, in addition to the product information. In several embodiments, the server system 118 further determines for each electronic product of the plurality of products, one or more of longevity of use by different users on the online social network 126, a possibility of repair after a malfunction, amount of recycled material used in composition, amount of recyclable material used in the composition, or a biodegradable composition, from one or more of the respective product information, the respective usage information, or the respective repair history.

At Step 608, the server system 118 receives a product category for purchase by the first user 110 via the at least one first electronic device 102. The received product category may, for example, indicate a product type, such as “refrigerator”, “laptop”, “smartphone”, “television”, etc. The received product category may also indicate a brand name, such as “Samsung Refrigerator”, “Apple iPhone”, “Sony Television”, etc. The received product category may alternately or additionally indicate desired features, such as “Smart TV with voice control”, “refrigerator with ice maker”, “laptop with dedicated graphics card”, etc. In several embodiments, the product category may indicate technical specifications, such as “55-inch TV”, “1 Tb laptop, “256 GB smartphone”, etc. Furthermore, in several embodiments, the product category may indicate a use case, such as “gaming laptop”, “office printer”. In addition, product category may also indicate price range, connectivity options, size and dimensions, etc.

At Step 610, the server system 118 provides one or more purchase recommendations to the at least one first electronic device 102 for the product category based at least on the environmental ratings of electronic products associated with the product category. In several embodiments, the server system 118, displays the one or more environmental ratings associated with the one or more respective purchase recommendations on a user interface generated by the at least one instance of the software application 124, at the at least one first electronic device 102.

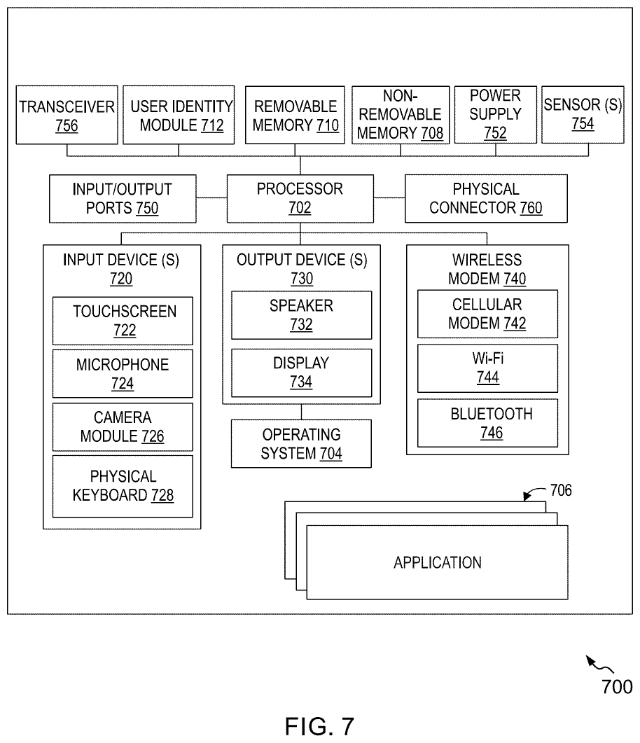

FIG. 7 is a simplified block diagram of an electronic device 700 for example, a mobile phone or a desktop computer capable of implementing the various embodiments of the present disclosure. For example, the electronic device 700 may correspond to the electronic devices 102-108 of FIG. 1. The electronic device 700 is depicted to include one or more applications, such as a recommendation application 706 facilitated by the server system 118. The recommendation application 706 can be an instance of an application downloaded from the server system 118 or a third-party server. The recommendation application 706 is capable of communicating with the server system 118 for managing environmental impact during a lifecycle of an electronic product shown in FIG. 1.

It should be understood that the electronic device 700 as illustrated and hereinafter described is merely illustrative of one type of device and should not be taken to limit the scope of the embodiments. As such, it should be appreciated that at least some of the components described below in connection with the electronic device 700 may be optional, and thus in an example embodiment may include more, less, or different components than those described in connection with the example embodiment of FIG. 7. As such, among other examples, the electronic device 700 could be any mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 700 includes a controller or a processor 702 (e.g., a signal processor, microprocessor, ASIC, or other control, and processing logic circuitry) for performing such tasks as signal coding, data processing, image processing, input/output processing, power control, and/or other functions. An operating system 704 controls the allocation and usage of the components of the electronic device 700 and supports one or more application programs, such as the application 706, that implement one or more of the innovative features described herein. In addition to the recommendation application 706, the applications may include common mobile computing applications (e.g., telephony applications, email applications, calendars, contact managers, web browsers, and messaging applications) or any other computing application.

The illustrated electronic device 700 includes one or more memory components, for example, a non-removable memory 708 and/or a removable memory 710. The non-removable memory 708 and the removable memory 710 may be collectively known as a database in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704 and the application 706. The electronic device 700 may further include a user identity module (UIM) 712. The UIM 712 may be a memory device having a processor built in.

The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in the form of the SIM card is well known in Global Systems for Mobile (GSM) communication systems, Code Division Multiple Access (CDMA) systems, or third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 700 can support one or more input devices 720 (hereinafter referred to as “input devices”) and one or more output devices 730 (hereinafter referred to as “output devices”). Examples of the input devices 720 may include, but are not limited to, a touch screen/a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited to, a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device, or a local wireless data network or router, and/or a Bluetooth-compatible modem 746. The wireless modem 740 is typically configured for communication with one or more cellular networks, such as a GSM network for data and voice communications within a single cellular network, between cellular networks, or between the electronic device 700 and a public switched telephone network (PSTN).

The electronic device 700 can further include one or more input/output ports 750, a power supply 752, one or more sensors 754 (e.g., an accelerometer, a gyroscope, a compass, or an infrared proximity sensor) for detecting the orientation or motion of the electronic device 700 and biometric sensors for scanning biometric identity of an authorized user, a transceiver 756 (for wirelessly transmitting analog or digital signals) and/or a physical connector 760, which can be a USB port, IEEE 794 (FireWire) port, and/or RS-232 port. The illustrated components are not required or all-inclusive, as any of the components shown can be deleted and other components can be added.

The disclosed method 600, or one or more operations of these methods may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers.

Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Particularly, the server system 118 and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or the computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media.

Examples of non-transitory computer-readable storage media include magnetic storage media (such as floppy disks, magnetic tapes, hard disk drives, etc.), optical magnetic storage media (e.g., magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method for facilitating environmentally conscious ownership of electronic products by users, the method comprising:
providing, by a server system, access to at least one instance of a software application, on at least one first electronic device associated with a first user and one or more second electronic devices associated with one or more second users, wherein the at least one instance of the software application is capable of enabling the at least one first electronic device to connect with the one or more second electronic devices, to configure an online social network of users;
receiving, by the server system, product information related to a plurality of electronic products owned by the one or more second users, wherein the product information is provided by the one or more second users to the at least one instance of the software application via the one or more respective second electronic devices;
determining, by the server system, an environmental rating for each electronic product of the plurality of electronic products based, at least in part, on the respective product information;
receiving, by the server system, a product category for purchase by the first user via the at least one first electronic device; and
providing, by the server system, one or more purchase recommendations to the at least one first electronic device for the product category based at least on the environmental ratings of electronic products associated with the product category.

2. The method as claimed in claim 1, wherein the at least one instance of the software application enables the at least one first electronic device to exchange one or more of text messages or multi-media messages with the one or more second electronic devices, through the online social network.

3. The method as claimed in claim 1, wherein the product information comprises one or more of a make, a model, a year of manufacture, or technical specifications of a respective electronic product of the plurality of electronic products.

4. The method as claimed in claim 1, further comprising receiving, by the server system, usage information and repair history of each electronic product of the plurality of electronic products, wherein the usage information and repair histories are provided by the one or more second users via the one or more respective second electronic devices.

5. The method as claimed in claim 4, further comprising determining, by the server system, for each electronic product of the plurality of products, one or more of longevity of use by different users on the online social network, a possibility of repair after malfunction, amount of recycled material used in composition, amount of recyclable material used in the composition, or a biodegradable composition, from one or more of the respective product information, the respective usage information, or the respective repair history.

6. The method as claimed in claim 4, wherein the environmental rating for the respective electronic product, is determined, by the server system, based, at least in part, on the usage information and the repair history, in addition to the product information.

7. The method as claimed in claim 1, further comprising displaying, by the server system, one or more environmental ratings associated with the one or more respective purchase recommendations on a user interface generated by the at least one instance of the software application, at the at least one first electronic device.

8. A server system for facilitating environmentally conscious ownership of electronic products by users, the server system comprising:
a memory unit configured to store machine-readable instructions;
a processor operably connected to the memory unit, the processor configured to execute the machine-readable instructions, that when executed enable the server system, at least in part, to:
provide access to at least one instance of a software application, on at least one first electronic device associated with a first user and one or more second electronic devices associated with one or more second users, wherein the at least one instance of the software application is capable of enabling the at least one first electronic device to connect with the one or more second electronic devices, to configure an online social network of users,
receive product information related to a plurality of electronic products owned by the one or more second users, wherein the product information is provided by the one or more second users to the at least one instance of the software application via the one or more respective second electronic devices,
determine an environmental rating for each electronic product of the plurality of electronic products based, at least in part, on the respective product information,
receive a product category for purchase by the first user via the at least one first electronic device, and
provide one or more purchase recommendations to the at least one first electronic device for the product category based at least on the environmental ratings of electronic products associated with the product category.

9. The server system as claimed in claim 8, wherein the at least one instance of the software application enables the at least one first electronic device to exchange one or more of text messages or multi-media messages with the one or more second electronic devices, through the online social network.

10. The server system as claimed in claim 8, wherein the product information comprises one or more of a make, a model, a year of manufacture, or technical specifications of a respective electronic product of the plurality of electronic products.

11. The server system as claimed in claim 8, wherein the server system is further enabled to receive usage information and repair history of each electronic product of the plurality of electronic products, wherein the usage information and repair histories are provided by the one or more second users via the one or more respective second electronic devices.

12. The server system as claimed in claim 11, wherein the server system is further enabled to determine, for each electronic product of the plurality of products, one or more of longevity of use by different users on the online social network, a possibility of repair after malfunction, amount of recycled material used in composition, amount of recyclable material used in the composition, or a biodegradable composition, from one or more of the respective product information, the respective usage information, or the respective repair history.

13. The server system as claimed in claim 11, wherein the server system is further enabled to determine the environmental rating for the respective electronic product, based, at least in part, on the usage information and the repair history, in addition to the product information.

14. The server system as claimed in claim 8, wherein the server system is further enabled to display one or more environmental ratings associated with the one or more respective purchase recommendations on a user interface generated by the at least one instance of the software application, at the at least one first electronic device.

15. A non-transitory computer-readable storage medium comprising machine-readable instructions that, when executed by at least a processor of a server system, enable the server system to perform a method comprising:
providing access to at least one instance of a software application, on at least one first electronic device associated with a first user and one or more second electronic devices associated with one or more second users, wherein the at least one instance of the software application is capable of enabling the at least one first electronic device to connect with the one or more second electronic devices, to configure an online social network of users;
receiving product information related to a plurality of electronic products owned by the one or more second users, wherein the product information is provided by the one or more second users to the at least one instance of the software application via the one or more respective second electronic devices;
determining an environmental rating for each electronic product of the plurality of electronic products based, at least in part, on the respective product information;
receiving a product category for purchase by the first user via the at least one first electronic device; and
providing one or more purchase recommendations to the at least one first electronic device for the product category based at least on the environmental ratings of electronic products associated with the product category.

16. The non-transitory computer-readable storage medium as claimed in claim 15, wherein the at least one instance of the software application enables the at least one first electronic device to exchange one or more of text messages or multi-media messages with the one or more second electronic devices, through the online social network.

17. The non-transitory computer-readable storage medium as claimed in claim 15, wherein the server system is further enabled to receive usage information and repair history of each electronic product of the plurality of electronic products, wherein the usage information and repair histories are provided by the one or more second users via the one or more respective second electronic devices.

18. The non-transitory computer-readable storage medium as claimed in claim 17, wherein the server system is further enabled to determine, for each electronic product of the plurality of products, one or more of longevity of use by different users on the online social network, a possibility of repair after malfunction, amount of recycled material used in composition, amount of recyclable material used in the composition, or a biodegradable composition, from one or more of the respective product information, the respective usage information, or the respective repair history.

19. The non-transitory computer-readable storage medium as claimed in claim 17, wherein the server system is further enabled to determine the environmental rating for the respective electronic product, based, at least in part, on the usage information and the repair history, in addition to the product information.

20. The non-transitory computer-readable storage medium as claimed in claim 15, wherein the server system is further enabled to display one or more environmental ratings associated with the one or more respective purchase recommendations on a user interface generated by the at least one instance of the software application, at the at least one first electronic device.
